(19) United States
(12) Patent Application Publication
(10) Pub. No.: US 2009/0073483 A1
(43) Pub. Date: Mar. 19, 2009

(54) PRINT INSTRUCTION APPARATUS, PRINTING APPARATUS, PRINTING SYSTEM, PRINT INSTRUCTION METHOD AND COMPUTER READABLE MEDIUM

(75) Inventor: Satoshi Oomori, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/056,321

(22) Filed: Mar. 27, 2008

(30) Foreign Application Priority Data
Sep. 19, 2007 (JP) 2007-242964

(51) Int. Cl. G06F 15/00

(52) U.S. Cl. 358/1.14; 358/1.15; 358/1.16

(57) ABSTRACT

The print instruction apparatus is provided with: a reception unit that receives a print request for printing an electronic document; a determination unit that determines whether or not particular information is associated with the electronic document; and an instruction unit that instructs a printing apparatus to temporarily store print information about the electronic document and impose restriction on printing on the basis of the print information until an operation device of the printing apparatus is operated, in the case where the determination unit determines that the particular information is associated with the electronic document.

### CROSS REFERENCE TO RELATED APPLICATIONS

This application is based on and claims priority under 35 USC §119 from Japanese Patent Application No. 2007-242964 filed Sep. 19, 2007.

### BACKGROUND

1. Technical Field

The present invention relates to a print instruction apparatus, a printing apparatus, a printing system, a print instruction method and a computer readable medium storing a program.

2. Related Art

There is a known technique that protects confidentiality of print data, when a printing apparatus outputs some print data.

### SUMMARY

According to an aspect of the invention, there is provided a print instruction apparatus including: a reception unit that receives a print request for printing an electronic document; a determination unit that determines whether or not particular information is associated with the electronic document; and an instruction unit that instructs a printing apparatus to temporarily store print information about the electronic document and impose restriction on printing on the basis of the print information until an operation device of the printing apparatus is operated, in the case where the determination unit determines that the particular information is associated with the electronic document.

### BRIEF DESCRIPTION OF THE DRAWINGS

Exemplary embodiment (s) of the present invention will be described in detail based on the following figures, wherein:

FIG. 1 shows a configuration of a network system to which the present exemplary embodiment is applied;

FIG. 2 is a view illustrating an example of the flow of creating, distributing and printing the electronic document;

FIG. 3 is a view illustrating an example of the information exchange among the application, the printer driver and the image forming apparatus;

FIG. 4 is a block diagram illustrating a functional configuration example of the client PC;

FIG. 5 is a flowchart illustrating an operation example of the application when the print password is set;

FIG. 6 is a flowchart illustrating a first operation example of the application when the electronic document is printed;

FIG. 7 is a flowchart illustrating a second operation example of the application when the electronic document is printed;

FIG. 8 is a flowchart illustrating an operation example of the printer driver when the printer driver receives the print instruction;

FIG. 9 is a block diagram illustrating a functional configuration example of the image forming apparatus;

FIG. 10 is a flowchart illustrating an operation example of the image forming apparatus when the security print is performed; and

FIG. 11 is a diagram illustrating the hardware configuration of the computer.

### DETAILED DESCRIPTION

Hereinafter, with reference to the drawings, a detailed description is given of a preferred embodiment for carrying out the invention (hereinafter, referred to as the “exemplary embodiment”).

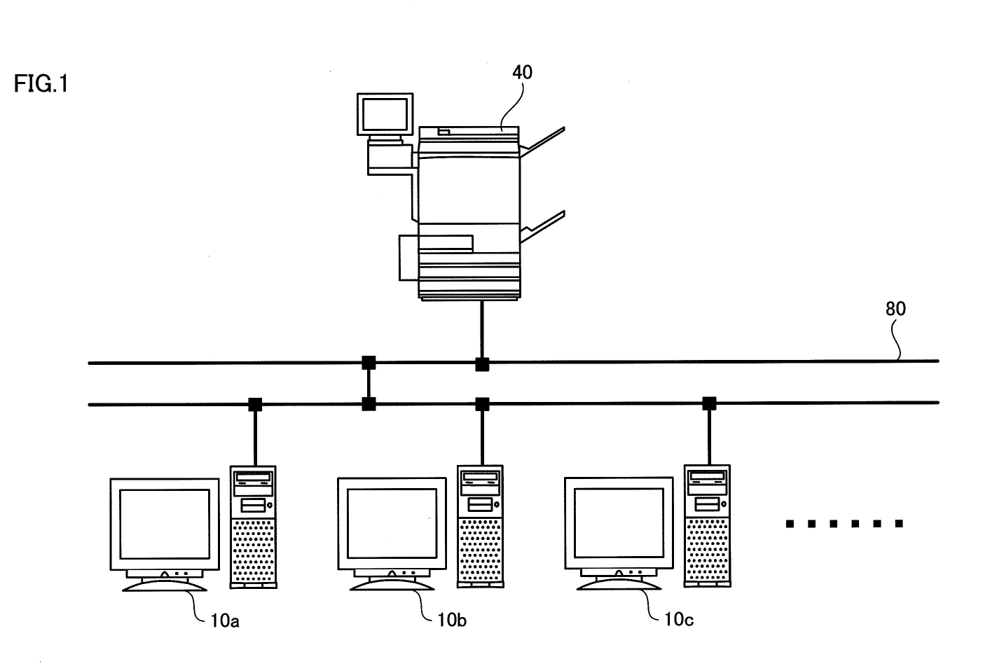

FIG. 1 shows a configuration of a network system to which the present exemplary embodiment is applied.

As shown in the figure, the network system is configured by connecting client PCs (personal computers) 10a, 10b and 10c and an image forming apparatus 40 by a network 80.

In the network system, the client PCs 10a, 10b and 10c are terminal apparatus that generate data to instruct printing in the image forming apparatus 40 (hereinafter, referred to as the “print data”), and transmit the print data to the image forming apparatus 40 through the network 80. Here, as the print data (print information), for example, PDLs (page description languages) may be preferably used. It should be noted that in the figure, although three client PCs are shown, the number of PCs is not limited to three. In the following, when a description is given by focusing attention on one arbitrary PC among the PCs, the PC may be mentioned as the “client PC 10”. In the present exemplary embodiment, as an example of a print instruction apparatus, the client PC 10 is provided.

The image forming apparatus 40 forms an image on a recording medium on the basis of the print data that is received from the client PCs 10a, 10b and 10c through the network 80. Here, the image forming apparatus 40 is, for example, a printer, and an electrophotographic method that forms an image by transferring toner adhered to a photo conductor to the recording medium, and an ink jet method that forms an image by jetting ink onto the recording medium may preferably be used. It should be noted that the recording medium may be made of any material on which an image is printable. Although a representative example of the recording medium is paper, an OHP sheet, a metal plate, cloth and the like may be used. The image forming apparatus 40 may be provided with not only a printer function that forms an image on the recording medium, but also multiple functions such as a scanner function that reads the image formed on the recording medium, a copying function that prints the read image to another recording medium, a facsimile function that transmits the read image to another image forming apparatus through a public line and the like. In the present exemplary embodiment, as an example of the printing apparatus, the image forming apparatus 40 is provided.

Further, as the network 80, a LAN (local area network) and the Internet may preferably be used. In the present exemplary embodiment, as an example of a communication unit, the network 80 is used.

When a highly confidential electronic document is printed in the image forming apparatus 40, there is a possibility that other persons will see a content of printed object in normal printing and confidentiality may not be maintained. Therefore, in recent years, the image forming apparatus 40 is sometimes provided with a function that is called a security print function, for example. Here, the security print function is a function that temporarily stores the print data in the image forming apparatus 40 without immediately performing printing on the basis of the print data received from the client PC 10 and performs printing on the basis of the print data at the time when a print instruction is performed from an operation part of the image forming apparatus 40 that is an example of an operation device. As the security print function, in a general method, printing on the basis of the print data is performed by setting a password at the time when the print data is transmitted from the client PC 10 and inputting the password at the time when the printing is instructed from the operation part of the image forming apparatus 40. Hereinafter, a mode that performs printing with using the security print function is called a “security print mode”, and a mode that performs printing without using the security print function is called a “normal mode”. It should be noted that the “security print function” may sometimes be called a “secure print function” or a “confidential print function”.

However, even when the image forming apparatus 40 is provided with the security print function, whether or not the printing is performed in the security print mode so as to maintain the confidentiality of the printed object always depends on a person who requests the printing (hereinafter, referred to as a “print requester”). That is, even with the electronic document that is created by a creator of the electronic document (hereinafter, referred to as a “document creator”) and is intended to be a highly confidential document, the confidentiality of the printed object is not maintained unless the print requester has the same intention as the document creator and it is difficult to say that the intention of the document creator is sufficiently reflected.

Therefore, in the present exemplary embodiment, the printing in the security print mode is specified not at the time of printing but at the time of creating the electronic document. At the time of printing the electronic document, the printing in the security print mode is mandatory.

Firstly, as an example of the case where the present exemplary embodiment is applied, a description is given of a flow of creating, distributing and printing the electronic document.

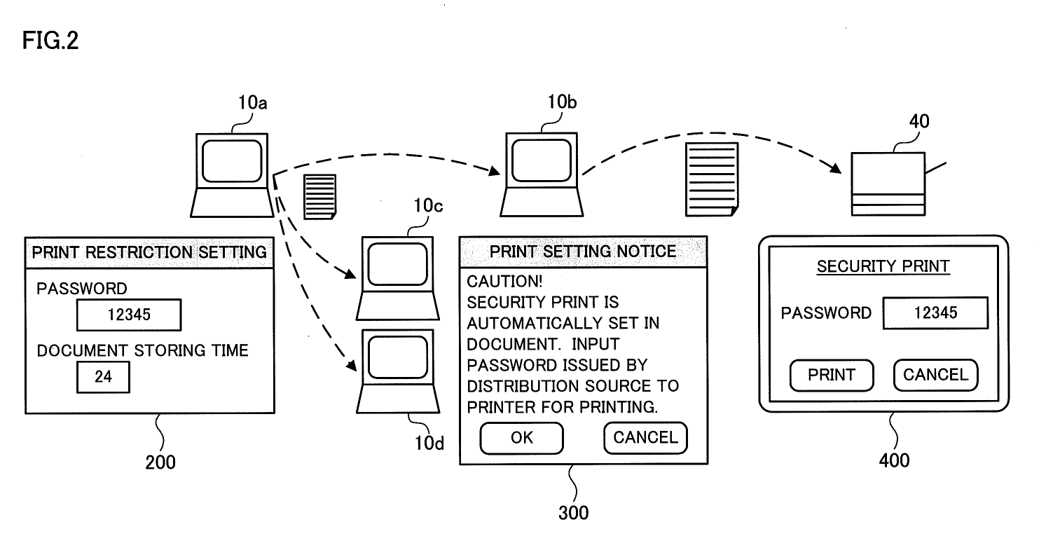

FIG. 2 is a view illustrating an example of the flow of creating, distributing and printing the electronic document.

Here, the document creator starts up an application program for creating a document (hereinafter, simply referred to as an “application”) in the client PC 10a, and creates the electronic document with using the application. At the time, the application displays a print restriction setting screen 200 as shown in the figure. In accordance with the display, the document creator inputs a print password that is used for printing in the security print mode and document storing time that is time restriction for storing the print data of the electronic document in the image forming apparatus 40. Then, the application stores the print password and the like as well as the electronic document. It should be noted that, although the document storing time is not necessarily inputted, in order to prevent the unprinted print data remaining in the image forming apparatus 40, the document storing time is inputted here.

Next, provided that the document creator distributes the electronic document to the client PCs 10b, 10c and 10d, and the print requester starts up the application in the client PC 10b and requests the printing of the electronic document. At the time, a printer driver displays a print setting notice screen 300 as shown in the figure. As a result, the print requester understands that the printing in the security print mode would be mandatory for the above electronic document.

Then, the print data of the electronic document is transmitted to the image forming apparatus 40, and stored in the image forming apparatus 40. At the time, restriction is imposed on the print data so as not to be printed immediately. In such a state, when the print requester operates the operation part of the image forming apparatus 40 and instructs to output the printed object, the image forming apparatus 40 displays a security print screen 400. In accordance with the display, the print requester inputs the print password given from the document creator and presses a print button. Then, the restriction that is imposed on the print data is released and the printed object is outputted.

As mentioned above, in the present exemplary embodiment, when the electronic document is created by the application, the print password is set in the electronic document. That is, depending on contents of the created electronic document, a security level is set. The print password is passed to the security print function of the image forming apparatus 40. That is, a security intention of the document creator for the electronic document is reflected to the printing after the distribution of the electronic document. In addition, by distributing a reference password other than the print password, whether the document is only referenced or even printed by a person who receives the password may be distinguished.

Next, a description is given of a flow of information exchange among an application 20 and a printer driver 30 that work in the client PC 10, and the image forming apparatus 40.

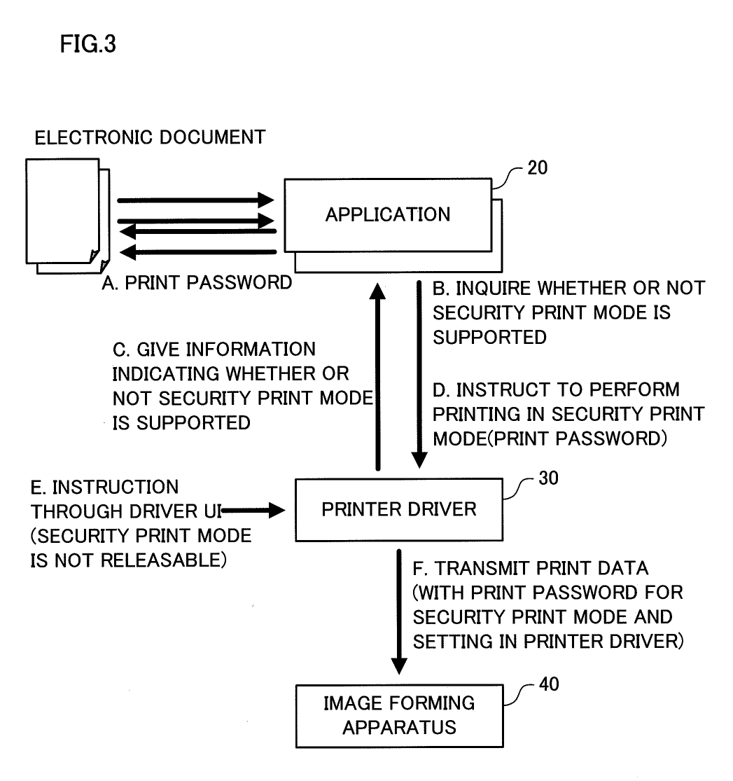

FIG. 3 is a view illustrating an example of the information exchange among the application 20, the printer driver 30 and the image forming apparatus 40. It should be noted that, in this example, the image forming apparatus 40 corresponds to the security print mode, and the printer driver 30 understands the correspondence.

As shown in the figure, firstly, the application 20 sets the print password for the electronic document (A). Here, the print password is information that is inputted to the operation part of the image forming apparatus 40 in order to release the restriction on the output of the printed object, in the case where the printing is performed in the security print mode. That is, in the present exemplary embodiment, as an example of release information that is designed to release the restriction imposed on the printing, the print password is used.

In the case where the electronic document in which the print password is set is printed, the application 20 inquires of the printer driver 30 whether or not the image forming apparatus 40 supports the security print mode (B).

Thereby, the printer driver 30 replies to the application 20 and gives information indicating whether or not the image forming apparatus 40 supports the security print mode (C). In this example, since the image forming apparatus 40 supports the security print mode, the printer driver 30 replies to the application 20 and gives the above fact.

As mentioned above, when the printer driver 30 replies, the application 20 delivers the information about the electronic document in which the print password is set to the printer driver 30, and instructs to perform the printing in the security print mode (D). At the time, the print password that is set in the electronic document is also delivered to the printer driver 30.

Then, the printer driver 30 displays an UI screen (the print setting notice screen 300 in FIG. 2) which notifies that the security print is mandatory, and waits for various instructions to the UI screen. However, the security print mode is not supposed to be releasable from the UI screen (E). The printer driver 30 transmits the print password in addition to the print data that is generated from the electronic document and various settings in the printer driver 30 to the image forming apparatus 40 (F). As a result, the print password that is set in the electronic document is also used as the password to be used in the security print mode.

Next, a description is given of the client PC 10 that performs such a general operation.

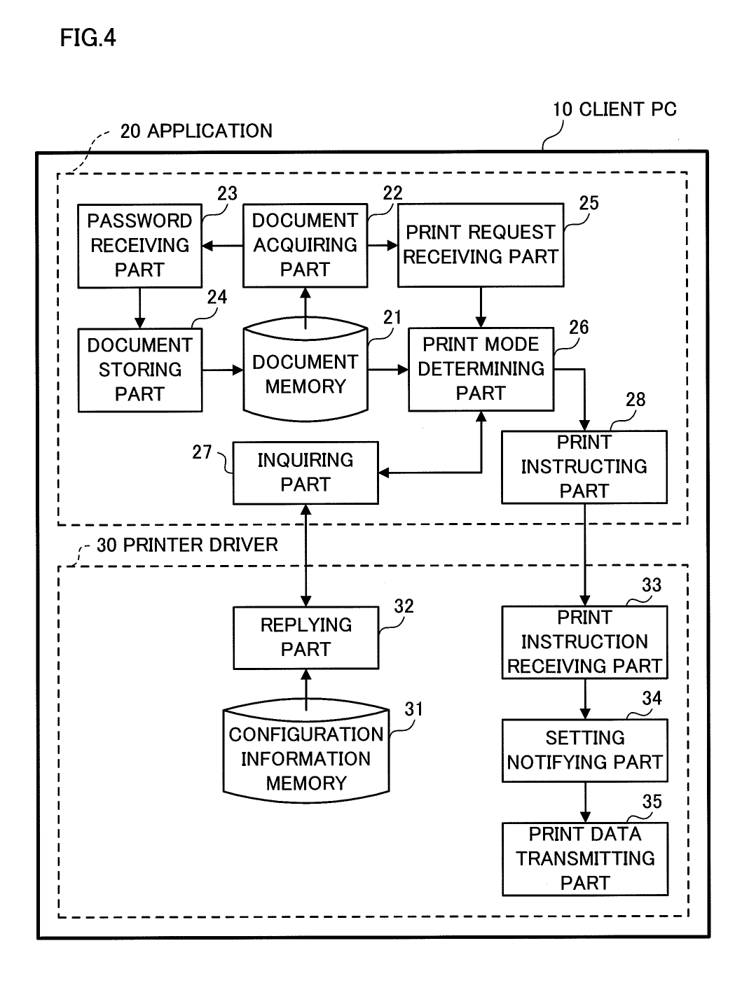

FIG. 4 is a block diagram illustrating a functional configuration example of the client PC 10. As mentioned above, the application 20 and the printer driver 30 are installed in the client PC 10. Then, descriptions are given separately of functions that are related to the application 20 and functions that are related to the printer driver 30.

Firstly, functions within a rectangle indicated by a broken line that represents the application 20 are the functions that are related to the application 20. That is, the client PC 10 is provided with a document memory 21, a document acquiring part 22, a password receiving part 23, a document storing part 24, a print request receiving part 25, a print mode determining part 26, an inquiring part 27 and a print instructing part 28 as the functions that are related to the application 20. The functions except the document memory 21 are functions that are realized by the execution of the application 20 by a CPU described later. Meanwhile, the document memory 21 is not realized by executing the application 20, but shown in the application 20 for convenience.

The document memory 21 stores the electronic document that is to be processed by the application 20. It should be noted that the document memory 21 may be realized in a magnetic disc apparatus described later, or in a main memory also described later.

The document acquiring part 22 reads out the electronic document that is stored in the document memory 21.

When the document creator specifies the print password to be set in the electronic document that is read by the document acquiring part 22, the password receiving part 23 receives the specified print password.

The document storing part 24 sets the print password that is received by the password receiving part 23 for the electronic document that is read by the document acquiring part 22, and stores the print password in the document memory 21. In the present exemplary embodiment, as an example of a storage unit that associates particular information with the electronic document and stores the particular information, the document storing part 24 is provided.

When the print requester inputs a print request for printing the electronic document that is read by the document acquiring part 22, the print request receiving part 25 receives the print request. In the present exemplary embodiment, as an example of a reception unit that receives the print request, the print request receiving part 25 is provided.

The print mode determining part 26 determines a print mode on the basis of a result of extracting the print password from the electronic document and a result of inquiring by the inquiring part 27. Here, the print mode indicates a printing method, that is, whether or not the electronic document is printed, or whether the printing is performed in the normal mode or the security print mode in the case where the electronic document is printed. In the present exemplary embodiment, as an example of a determination unit that determines whether or not the particular information is associated with the electronic document, and as an example of a decision unit that decides not to print the electronic document in a predetermined case, the print mode determining part 26 is provided.

The inquiring part 27 inquires of the printer driver 30 whether or not the image forming apparatus 40 supports the security print mode, and returns the result of the inquiry to the print mode determining part 26.

The print instructing part 28 instructs the printer driver 30 to print the electronic document, in the case where the print mode determining part 26 determines that the print instruction of the electronic document is to be performed.

Functions within a rectangle indicated by a broken line that represents the printer driver 30 are the functions that are related to the printer driver 30. That is, the client PC 10 is provided with a configuration information memory 31, a replying part 32, a print instruction receiving part 33, a setting notifying part 34 and a print data transmitting part 35 as the functions that are related to the printer driver 30. All the functions are functions that are realized by the execution of the printer driver 30 by the CPU described later.

The configuration information memory 31 stores information that is related to a configuration of the image forming apparatus 40 (configuration information). Here, for example, in the case where information that is related to a configuration optionally added to the image forming apparatus 40 is stored as the configuration information, the information may preferably be acquired from the image forming apparatus 40 using a protocol such as an SNMP (simple network management protocol). It should be noted that the configuration information memory 31 may be realized in the magnetic disc apparatus described later, or in the main memory also described later.

The replying part 32 references the configuration information that is stored in the configuration information memory 31 and replies to the inquiry from the inquiring part 27 of the application 20.

The print instruction receiving part 33 receives the print instruction of the electronic document from the print instructing part 28 of the application 20. It should be noted that, at the time, the print instruction receiving part 33 also receives information on whether the electronic document should be printed in the security print mode or in the normal mode.

The setting notifying part 34 displays the UI screen (a notice screen) which notifies that the security print is mandatory, in the case where the printing in the security print mode is instructed. The setting notifying part 34 also displays information such as a user ID and a document name on the notice screen, and receives instruction to change the above information.

The print data transmitting part 35 transmits the print data to the image forming apparatus 40. It should be noted that, at the time, the print data transmitting part 35 also transmits the print password to the image forming apparatus 40. In the present exemplary embodiment, as an example of an instruction unit that instructs the printing apparatus, and as an example of a transmission unit that transmits the print information and instruction information, the print data transmitting part 35 is provided.

Next, a description is given of an operation of the client PC 10 in the present exemplary embodiment.

Firstly, a description is given of an operation of the application 20 on the client PC 10 when the print password is set in the electronic document.

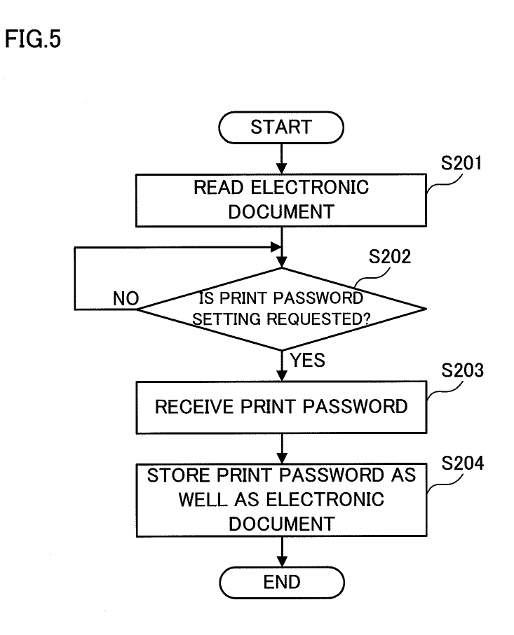

FIG. 5 is a flowchart illustrating an operation example of the application 20 at the time.

When the application 20 is started up and display of a predetermined electronic document is requested, the document acquiring part 22 reads the specified electronic document from the document memory 21 and displays the electronic document on a display of the client PC 10 (Step 201). As well as a general application program for creating a document, the application 20 follows instruction of a user and processes editing, storage, printing and the like of the document.

In the present exemplary embodiment, in addition to the above, there is sometimes a case where the application 20 receives a request for setting the print password. Therefore, the password receiving part 23 determines whether or not the request for setting the print password is performed (Step 202). Here, the print password is, as mentioned above, a password to be inputted to the operation part of the image forming apparatus 40 when the printing of the print data of the electronic document is instructed in a state of the print data being stored in the image forming apparatus 40. The request for setting the print password may be performed by selecting a menu item that corresponds to the request for setting among the menu items that are supplied by the application 20, for example.

Here, when the request for setting the print password is not performed, Step 202 is repeated. However, when the request for setting the print password is performed, the password receiving part 23 receives the inputted print password (Step 203). Specifically, a password input screen (the print restriction setting screen 200 in FIG. 2) may preferably be displayed on the display of the client PC 10 so that the print password may be inputted to the password input screen. Then, the document storing part 24 stores the received print password as well as the electronic document that is currently being displayed in the document memory 21 (Step 204).

Next, a description is given of an operation of the application 20 on the client PC 10 when the electronic document is printed.

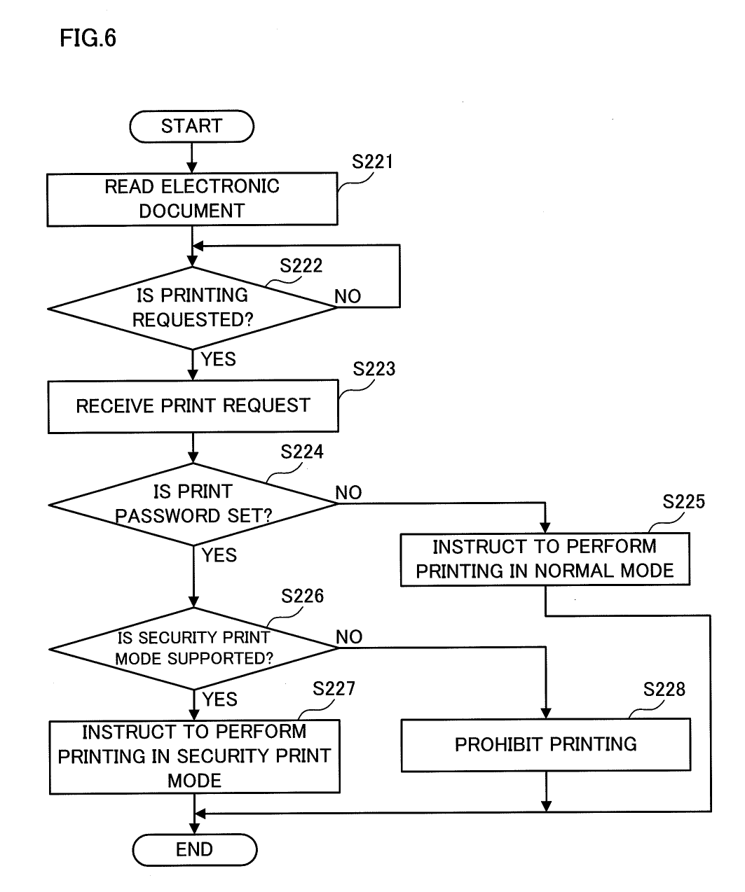

FIG. 6 is a flowchart illustrating a first operation example of the application 20 when the electronic document is printed.

When the application 20 is started up and display of a predetermined electronic document is requested, the document acquiring part 22 reads the specified electronic document from the document memory 21 and displays the electronic document on the display of the client PC 10 (Step 221).

The application 20 determines whether or not the print request for printing the electronic document is performed (Step 222). The print request may be performed by selecting a menu item that corresponds to the print request among the menu items that are supplied by the application 20 for example, as performed in a conventional application program for creating a document.

Here, when the print request is not performed, Step 222 is repeated. However, when the print request is performed, the print request receiving part 25 receives the print request (Step 223). Next, the print mode determining part 26 determines whether or not the print password is set in the electronic document to be printed (Step 224).

As a result, when the print mode determining part 26 determines that the print password is not set, the print mode determining part 26 decides to perform printing in the normal mode, and the print instructing part 28 instructs the printer driver 30 to perform such printing (Step 225).

Meanwhile, when the print mode determining part 26 determines that the print password is set, the inquiring part 27 inquires of the printer driver 30 whether or not the image forming apparatus 40 supports the security print mode (Step 226). In the case where the replying part 32 returns the information that the image forming apparatus 40 supports the security print mode in reply to the above, the print mode determining part 26 decides to perform printing in the security print mode, and the print instructing part 28 instructs the printer driver 30 to perform such printing (Step 227). It should be noted that, at the time, the print instructing part 28 also delivers the print password that is set in the electronic document to the printer driver 30. In the case where the replying part 32 returns the information that the image forming apparatus 40 does not support the security print mode, the print mode determining part 26 decides not to print the electronic document (Step 228). That is, although the document creator has an intention of printing in the security print mode at the time of creating the electronic document, the printing that satisfies the intention is unattainable. Therefore, the printing itself is prohibited.

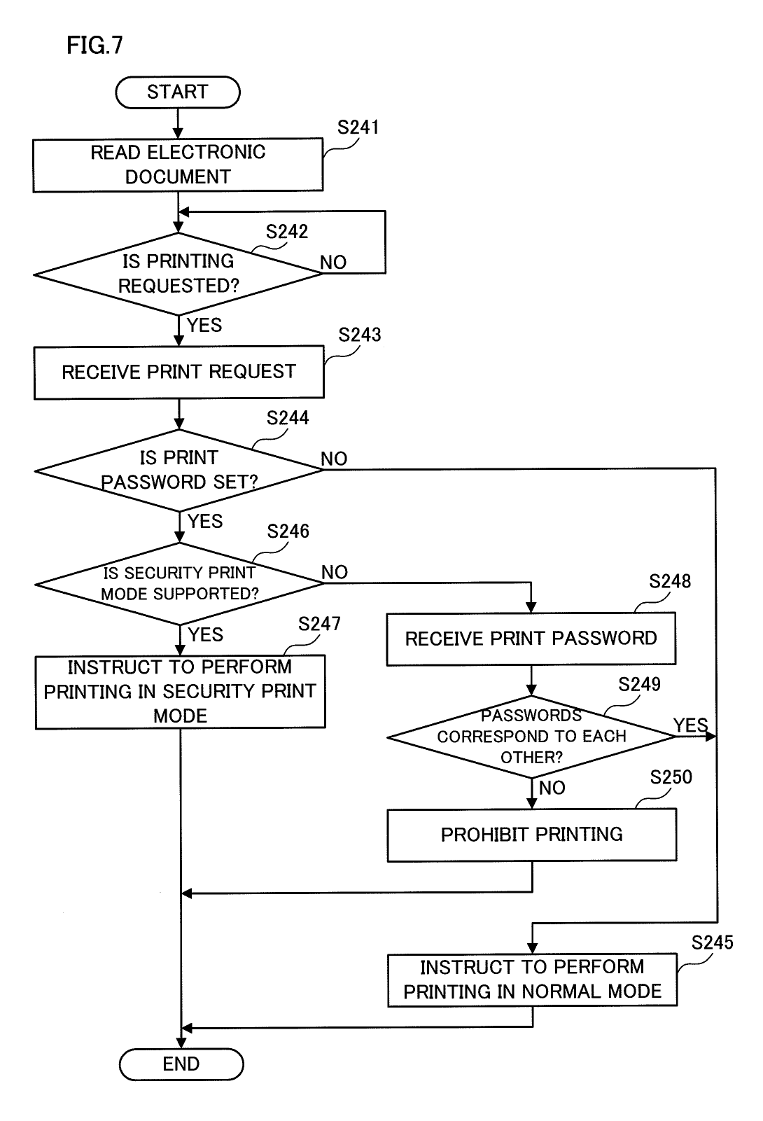

FIG. 7 is a flowchart illustrating a second operation example of the application 20 when the electronic document is printed.

In the second operation example, Steps 241 to 247 are the same as Steps 221 to 227 of FIG. 6. Since what is different from FIG. 6 is only an operation in the case where the determination in Step 246 is “No”, a description is given of the above part. In FIG. 6, when there is not the image forming apparatus 40 that supports the security print mode, the electronic document in which the print password is set is not printed at all. However, in the second operation example, such inconvenience is avoided.

That is, in the case where the replying part 32 returns the information that the image forming apparatus 40 does not support the security print mode in reply to the inquiry in Step 246, the print mode determining part 26 receives the inputted print password (Step 248). Specifically, the password input screen may be displayed on the display of the client PC 10 so that the print password is inputted to the password input screen. The print mode determining part 26 determines whether or not the inputted print password corresponds to the print password that is set in the electronic document (Step 249). As a result, in the case where the print mode determining part 26 determines that both the print passwords correspond to each other, the print mode determining part 26 determines that the electronic document is printed in the normal mode, and the print instructing part 28 instructs the printer driver 30 to perform such printing (Step 245). In the case where the print mode determining part 26 determines that both the print passwords do not correspond to each other, the print mode determining part 26 determines that the electronic document is not printed (Step 250). That is, here, a person who knows the print password that is set in the electronic document is authorized to be a right print requester. However, the print password is not necessarily used for authorizing the right print requester, but other predetermined information may be inputted for inspecting whether or not the person is the right print requester.

It should be noted that, in the above, descriptions are given of the two operation examples as the operation of the application 20 at the time of printing. However, instead of considering the above two operations as independent, the two operations may be combined. For example, in the case where the image forming apparatus 40 does not support the security print mode, the document creator may preliminarily set in the electronic document whether the printing of the electronic document is prohibited as in the first operation example, or the printing of the electronic document is permitted when the password that is inputted at the time of printing and the set password correspond to each other as in the second operation example.

Next, a description is given of an operation of the printer driver 30 on the client PC 10 when the electronic document is printed.

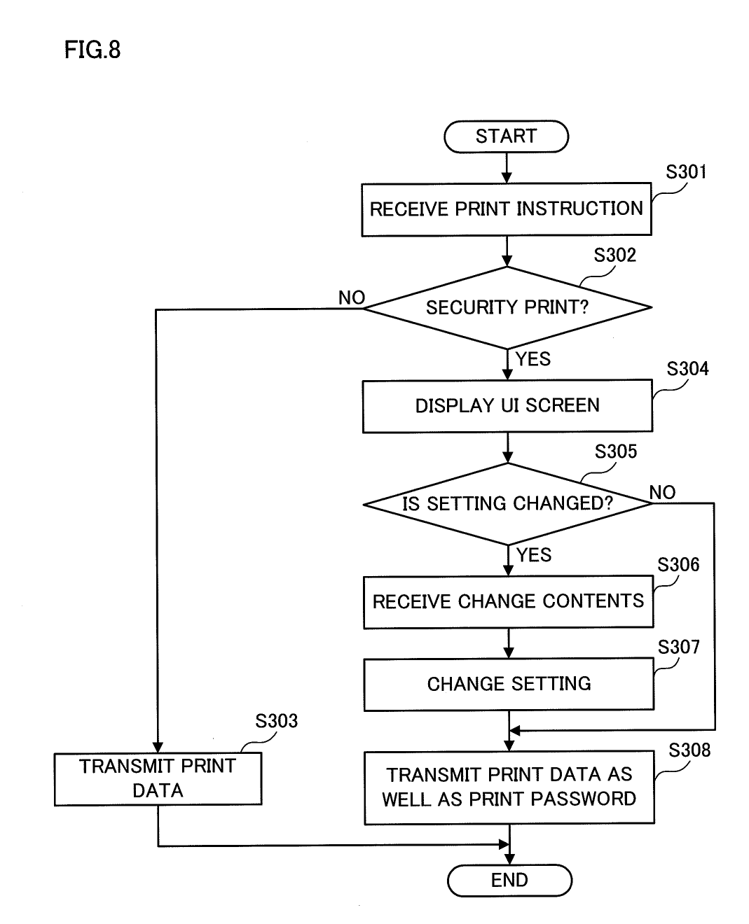

FIG. 8 is a flowchart illustrating an operation example of the printer driver 30 at the time.

When the print instruction is performed by the application 20, in the printer driver 30, the print instruction receiving part 33 receives the print instruction (Step 301). The print instruction receiving part 33 determines whether or not the above print instruction is to instruct the printing in the security print mode (Step 302).

Here, when the printing in the security print mode is not instructed, that is, when the printing in the normal mode is instructed, the print data transmitting part 35 transmits the print data that is generated from the electronic document to the image forming apparatus 40 as usual (Step 303).

Meanwhile, when the printing in the security mode is instructed, the setting notifying part 34 displays the UI screen (the notice screen) that notifies that the security print mode is mandatory in the electronic document to be printed (Step 304). The notice screen is formed so as not to release the security print mode.

Further, the user ID and the document name that help search for the electronic document to be printed by the print instruction by operating the operation part of the image forming apparatus 40 are displayed on the notice screen. As the user ID and the document name, for example, values that are delivered from an OS (an operating system) are displayed as default values. However, such default values are not sufficient to search for the electronic document to be printed by the print instruction of the print requester, and there is sometimes a case where the print requester desires to change the above values into other values. Therefore, the setting notifying part 34 determines whether or not there is a change request for changing the user ID and the document name (Step 305). As a result, when there is the change request for changing the user ID and the document name, the setting notifying part 34 receives the change request (Step 306). The printer driver 30 replaces the user ID and the document name that the printer driver 30 holds at the time with a user ID and a document name reflecting the change (Step 307). Meanwhile, when there is no change request for changing the user ID and the document name, no change is performed.

Then, the print data transmitting part 35 transmits the print data that is generated from the electronic document and the print password that is delivered from the application 20 to the image forming apparatus 40 (Step 308). It should be noted that, at the time, the user ID and the document name are also transmitted to the image forming apparatus 40. Here, when having been already changed in Step 307, the user ID and the document name are the user ID and the document name reflecting the change, and when not having been changed in Step 307, the user ID and the document name are the default values.

Next, a description is given of the image forming apparatus 40 that performs the outline operation mentioned above.

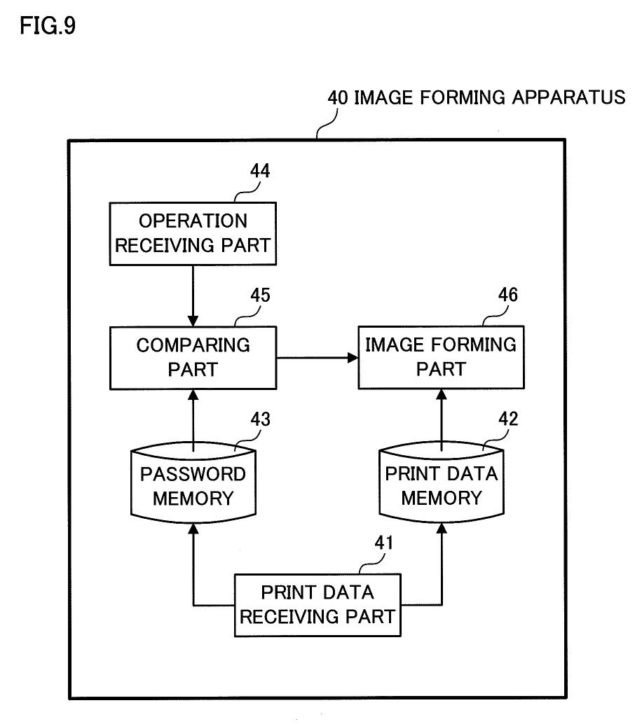

FIG. 9 is a block diagram illustrating a functional configuration example of the image forming apparatus 40. As shown in the figure, the image forming apparatus 40 is provided with a print data receiving part 41, a print data memory 42, a password memory 43, an operation receiving part 44, a comparing part 45 and an image forming part 46.

The print data receiving part 41 receives the print data from the printer driver 30 of the client PC 10. At the time, in the present exemplary embodiment, the print password is also received.

The print data memory 42 stores the print data that is received in the print data receiving part 41. In the present exemplary embodiment, as an example of a memory that stores the print information, the print data memory 42 is provided.

The password memory 43 stores the print password that is received in the print data receiving part 41.

The operation receiving part 44 receives the print password that is inputted by the user. In the present exemplary embodiment, as an example of the reception unit that receives the print instruction, the operation receiving part 44 is provided.

The comparing part 45 compares the print password that is stored in the password memory 43 with the print password that is received by the operation receiving part 44 and instructs the image forming part 46 to form an image when the above print passwords correspond to each other. In other words, the comparing part 45 restricts the printing until the operation receiving part 44 receives the print password that is stored in the password memory 43. That is, in the present exemplary embodiment, as an example of a restriction unit that imposes the restriction on the printing, the comparing unit 45 is provided.

The image forming unit 46 forms an image on the recording medium by, for example, the electrophotographic method on the basis of the print data that is stored in the print data memory 42. It should be noted that when the image is formed on the basis of the print data, there is a need for performing various image processing such as rasterization of the print data and color conversion. However, in the figure, the above image processing is omitted.

Next, a description is given of an operation of the image forming apparatus 40 when the security print is performed.

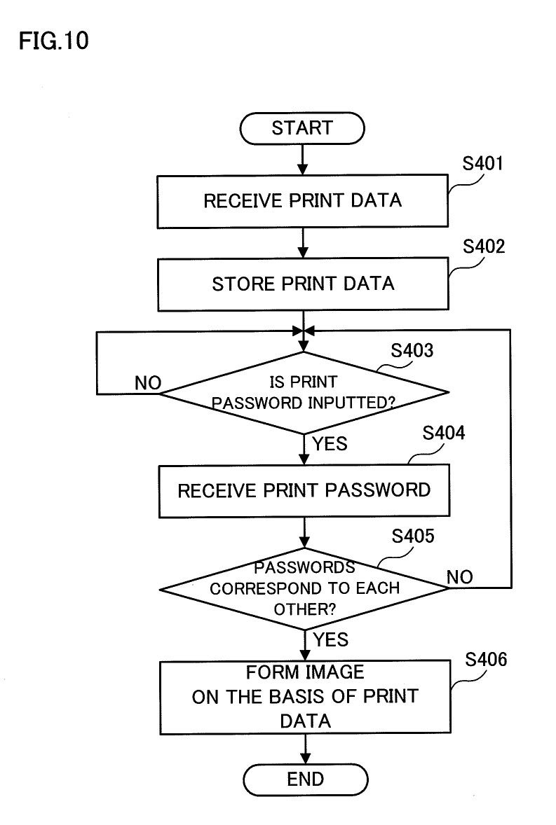

FIG. 10 is a flowchart illustrating an operation example of the image forming apparatus 40 at the time.

When the print data is transmitted from the client PC 10, in the image forming apparatus 40, the print data receiving part 41 firstly receives the print data (Step 401). At the time, the print password is also received in the print data receiving part 41. The print data receiving part 41 stores the print data in the print data memory 42 and the print password in the password memory 43 (Step 402).

Next, the operation receiving part 44 determines whether or not the print password is inputted from the operation part (Step 403). When the print password is not inputted, Step 403 is repeated. However, when the print password is inputted, the operation receiving part 44 receives the inputted print password (Step 404). Then, the comparing part 45 determines whether or not the inputted print password and the print password that is stored in the password memory 43 correspond to each other (Step 405).

As a result, when the above print passwords correspond to each other, the image forming part 46 forms an image on the recording medium on the basis of the print data that is stored in the print data memory 42 (Step 406). Meanwhile, when the above print passwords do not correspond to each other, the flow returns to Step 403 and the operation receiving part 44 determines whether or not the print password is inputted from the operation part again.

In the above, the detailed description is given of the present exemplary embodiment. However, various other variations may be made.

Firstly, although, in the present exemplary embodiment, the document creator sets the print password to be used in the security print mode in the electronic document, the information to be set is not limited to the above. For example, the instruction information that instructs to perform the printing in the security print mode may be set in the electronic document. It should be noted that, in such a case, only the print instruction in the security print mode is transmitted from the application 20 to the printer driver 30, and the print password is not transmitted. Therefore, in the printer driver 30, the password input screen may be popped up so that the password is inputted, and the above password may be transmitted as the password to be used in the security print mode.

In the present exemplary embodiment, the description is given of the case where the print instruction from the application 20 to the image forming apparatus 40 is performed through the printer driver 30. However, when the image forming apparatus 40 is provided with a function that interprets the electronic document, the print instruction may be performed without the printer driver 30. In such a case, in the image forming apparatus 40, an electronic document receiving part (not shown in the figure) receives the electronic document directly from the application 20. A print mode determining part (not shown in the figure) performs the same processing as is performed by the print mode determining part 26 in the application 20 mentioned above. That is, the print mode determining part analyzes whether or not the print password is set in the electronic document, and determines whether or not the electronic document is printed and whether the printing is performed in the normal mode or in the security print mode in the case where the electronic document is printed. It should be noted that, here, as an example of a receiving unit that receives the electronic document, the electronic document receiving part is provided, and as an example of a determination unit that determines whether or not the particular information is associated with the electronic document, the print mode determining part is provided.

Further, in the case where the print instruction from the application 20 to the image forming apparatus 40 is performed without the printer driver 30 as mentioned above, the application 20 itself judges whether or not the image forming apparatus 40 corresponds to the security print mode. Such judgment may be performed by, for example, matching with a model name of the image forming apparatus 40, or acquiring the configuration information about the image forming apparatus 40 using the SNMP.

Finally, a description will be given of a hardware configuration of the client PC 10 and a part that performs the above-described processing of the image forming apparatus 40 as a hardware configuration of the general-purpose computer 90.

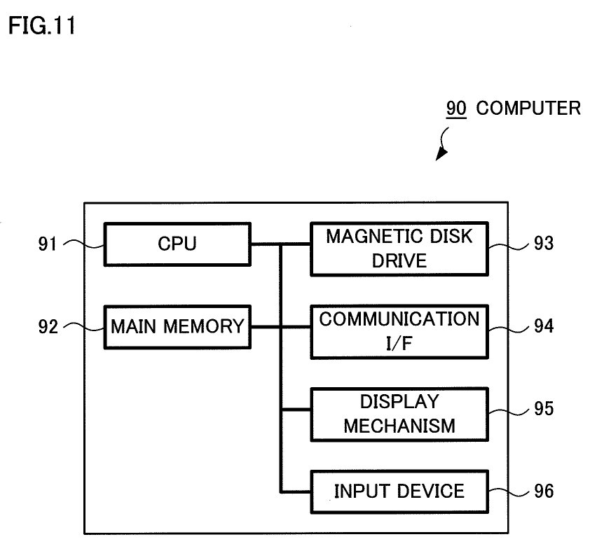

FIG. 11 is a diagram illustrating the hardware configuration of the computer 90. As shown in the figure, the computer 90 is provided with a CPU (Central Processing Unit) 91 that is an example of a computing unit, a main memory 92 and a magnetic disk drive (HDD: hard disk drive) 93 that are an example of a memory. Here, the CPU 91 executes various kinds of software such as OS (Operating System) and applications, and realizes the various functions described above. In addition, the main memory 92 has a memory area that stores the various kinds of software and data to be used for executing the software and the like. Further, the magnetic disk drive 93 has a memory area that stores input data to the various kinds of software, output data from the various kinds of software and the like.

Moreover, the computer 90 is provided with a communication I/F 94 that communicates with the external, a display mechanism 95 that includes a video memory, a display and the like, and the input device 96 such as a keyboard and a mouse.

It should be noted that the program that realizes the present exemplary embodiment may be provided not only by a communication unit but also by being stored in a memory medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print instruction apparatus comprising:
a reception unit that receives a print request for printing an electronic document;
a determination unit that determines whether or not particular information is associated with the electronic document; and
an instruction unit that instructs a printing apparatus to temporarily store print information about the electronic document and impose restriction on printing on the basis of the print information until an operation device of the printing apparatus is operated, in the case where the determination unit determines that the particular information is associated with the electronic document.

2. The print instruction apparatus according to claim 1, further comprising a storage unit that, when the particular information is inputted by a creator of the electronic document, associates the particular information with the electronic document and stores the particular information.

3. The print instruction apparatus according to claim 1, wherein
the particular information includes release information for releasing the restriction, and
the instruction unit instructs the printing apparatus to release the restriction in accordance with the release information inputted from the operation device.

4. The print instruction apparatus according to claim 1, further comprising a decision unit that decides to stop printing the electronic document, in the case where the printing apparatus does not impose the restriction on the printing on the basis of the temporarily-stored print information about the electronic document until the operation device of the printing apparatus is operated.

5. The print instruction apparatus according to claim 1, wherein the instruction unit instructs the printing apparatus to print the electronic document under the condition that predetermined information is inputted, in the case where the printing apparatus does not impose the restriction on the printing on the basis of the temporarily-stored print information about the electronic document until the operation device of the printing apparatus is operated.

6. A print instruction apparatus comprising:
a reception unit that receives a print request for printing an electronic document;
a determination unit that determines whether or not particular information is associated with the electronic document; and
an instruction unit that instructs a printing apparatus to print the electronic document under the condition that predetermined information is inputted, in the case where the determination unit determines that the particular information is associated with the electronic document and also in the case where the printing apparatus to be used for printing does not impose restriction on printing on the basis of the temporarily-stored print information about the electronic document until an operation device of the printing apparatus is operated.

7. A printing apparatus comprising:
a receiving unit that receives print information about an electronic document from a communication unit;
a memory that stores the print information received by the receiving unit;
a reception unit that receives, from an operation device, a print instruction on the basis of the print information stored in the memory;
a determination unit that determines whether or not particular information is associated with the electronic document; and
a restriction unit that imposes restriction on printing on the basis of the print information until the reception unit receives the print instruction on the basis of the print information, in the case where the determination unit determines that the particular information is associated with the electronic document.

8. The printing apparatus according to claim 7, wherein
the particular information includes release information for releasing the restriction, and
the reception unit receives, in the case where the release information is inputted from the operation device, the inputted release information as the print instruction on the basis of the print information.

9. A printing system comprising:
a print instruction apparatus that performs a print instruction of an electronic document; and
a printing apparatus that prints the electronic document in accordance with the print instruction,
the print instruction apparatus having:
a determination unit that determines whether or not particular information is associated with the electronic document; and
a transmission unit that transmits, to the printing apparatus, print information about the electronic document and instruction information for instructing to temporarily store the print information and to impose restriction on printing on the basis of the print information until an operation device of the printing apparatus is operated, in the case where the determination unit determines that the particular information is associated with the electronic document,
the printing apparatus having:
a receiving unit that receives the print information and the instruction information from the print instruction apparatus;
a memory that stores the print information received by the receiving unit; and
a restriction unit that imposes the restriction on the printing on the basis of the print information until the print instruction on the basis of the print information stored in the memory is performed from the operation device of the printing apparatus.

10. A print instruction method comprising:
receiving a print request for printing an electronic document from any one of a person who requests a printing apparatus to print the electronic document and an application program that creates the electronic document;
determining whether or not particular information is associated with the electronic document; and
instructing the printing apparatus to temporarily store print information about the electronic document and to impose restriction on printing on the basis of the print information until an operation device of the printing apparatus is operated, in the case where the particular information is determined to be associated with the electronic document.

11. A computer readable medium storing a program causing a computer to execute a process for protecting confidentiality of print data, the process comprising:
acquiring instruction information, in the case where, prior to printing an electronic document, a creator of the electronic document inputs the instruction information that instructs, upon printing the electronic document, to temporarily store print information about the electronic document in a printing apparatus and to impose restriction on printing on the basis of the print information until an operation device of the printing apparatus is operated; and
associating the acquired instruction information with the electronic document and storing the instruction information.

12. The computer readable medium according to claim 11, wherein the instruction information includes release information for releasing the restriction.

13. A computer readable medium storing a program causing a computer to execute a process for protecting confidentiality of print data, the process comprising:
receiving a print request for printing an electronic document from a person who requests a printing apparatus to print the electronic document;
determining whether or not particular information is associated with the electronic document; and
instructing the printing apparatus to temporarily store print information about the electronic document and to impose restriction on printing on the basis of the print information until an operation device of the printing apparatus is operated, in the case where the particular information is determined to be associated with the electronic document.

14. The computer readable medium according to claim 13, wherein
the particular information includes release information for releasing the restriction, and
the process of instructing instructs the printing apparatus to release the restriction in accordance with the release information inputted from the operation device.

15. The computer readable medium according to claim 13, the process further comprising deciding to stop printing the electronic document, in the case where the printing apparatus does not impose the restriction on the printing on the basis of the temporarily-stored print information about the electronic document until the operation device of the printing apparatus is operated.

16. The computer readable medium according to claim 13, wherein the process of instructing instructs the printing apparatus to print the electronic document under the condition that predetermined information is inputted, in the case where the printing apparatus does not impose the restriction on the printing on the basis of the temporarily-stored print information about the electronic document until the operation device of the printing apparatus is operated.

17. A computer readable medium storing a program causing a computer to execute a process for protecting confidentiality of print data, the process comprising:
receiving a print instruction of an electronic document from an application program that creates the electronic document;
determining whether or not particular information is associated with the electronic document; and
instructing a printing apparatus to temporarily store print information about the electronic document and to impose restriction on printing on the basis of the print information until an operation device of the printing apparatus is operated, in the case where the particular information is determined to be associated with the electronic document.

18. The computer readable medium according to claim 17, the process further comprising displaying a notice screen that notifies that the print information about the electronic document is temporarily stored in the printing apparatus and the restriction is imposed on the printing on the basis of the print information until the operation device of the printing apparatus is operated.

19. The computer readable medium according to claim 18, wherein the notice screen is formed so as not to allow setting of the restriction to be changed, the setting of the restriction being to temporarily store the print information about the electronic document in the printing apparatus and to impose the restriction on the printing on the basis of the print information until the operation device of the printing apparatus is operated.

20. The computer readable medium according to claim 18, wherein the notice screen is formed so as to change information that helps search for the print information about the electronic document in the operation device.
